(19) United States
(12) Patent Application Publication
(10) Pub. No.: US 2006/0212300 A1
(43) Pub. Date: Sep. 21, 2006

(54) System and method for providing vehicle information from a telematics window sticker

(75) Inventors: Brad T. Resser, Lake Orion, MI (US); Russell A. Patenaude, Macomb Township, MI (US); Shpetim S. Veliu, Livonia, MI (US); Anthony J. Sumcad, Southfield, MI (US)

Correspondence Address: General Motors Corporation;Legal Staff, Mail Code 482-C23-B21, 300 Renaissance Center, P.O. Box 300, Detroit, MI, 48265-3000, US

(73) Assignee: General Motors Corporation

(21) Appl. No.: 11/080,299

(22) Filed: Mar. 15, 2005

(51) Int. Cl. G06Q 99/00

(52) U.S. Cl. 705/1

(57) ABSTRACT

A method of receiving vehicle sales information at a telematics unit in a vehicle via a wireless connection from a control node includes receiving a trigger input at the telematics unit and providing the vehicle sales information to a local customer responsive to the received trigger input.

### FIELD OF THE INVENTION

This invention relates generally to providing vehicle sales information to a customer in the market for a vehicle via a telematics unit.

### BACKGROUND OF THE INVENTION

When a prospective customer visits a vehicle dealership to shop for a vehicle, the information about the vehicle features is listed on a window sticker on the vehicle window. Often the vehicle features are abbreviated or described using acronyms, such as, ABS to indicate Anti-lock Brake System. If a component or feature in the vehicle is non-standard or is based on a new technology, the customer may not understand the value of the component or feature. Currently, a salesperson in the dealership needs to interact with the customer to inform them of all the advantages of the various features.

A customer browsing in the vehicle show room or on the dealership lot may not find a vehicle with the exact features they want. To assist that customer, a vehicle salesperson is required to look up information about all the vehicles on the lot for the customer to determine if a vehicle with all the desired features is currently on the dealership lot.

In some cases, the dealership is busy and the customer cannot get the attention of a vehicle salesperson in order to have questions answered about the vehicle features and the vehicles available on the lot. If a customer browses the dealership lot without seeing a vehicle with the exact features that they want, the customer may assume their desired vehicle is not available. In this case, if the vehicle is on the lot but is overlooked by the customer and the customer does not wait for a salesperson to become available to talk with them, a sale can be lost for the dealership.

If a customer is in the early stages of shopping for a vehicle, they may prefer to look at the vehicles without talking with a vehicle salesperson. In this case, the customer may leave the dealership without a clear understanding of the advantages of the vehicle features.

In some cases, the information on the window sticker is outdated. For example, if a standard radio was replaced with a satellite radio, the sticker may not be updated immediately to reflect the change in the vehicle component and a customer can be misinformed about the vehicle features. The sticker on the window can also detract from the visual appeal of the vehicle.

It is desirable, therefore, to provide a potential customer with vehicle details, such as the advantages of the vehicle features, the prices of each feature, and the availability of vehicles on the lot with desired features, without a vehicle salesperson being present.

### SUMMARY OF THE INVENTION

One aspect of the present invention provides a method of receiving vehicle sales information at a telematics unit in a vehicle via a wireless connection from a control node, receiving a trigger input at the telematics unit and providing the vehicle sales information to a local customer responsive to the received trigger input.

Another aspect of the present invention provides computer readable medium storing a computer program including computer readable code operable for receiving vehicle sales information at a vehicle telematics unit via a wireless connection from a control node, receiving a trigger input at the telematics unit, and providing the vehicle sales information to a local customer responsive to the received trigger input.

A third aspect of the present invention provides a system to provide vehicle information including means for receiving vehicle sales information at a vehicle telematics unit via a wireless connection from a control node, means for receiving a trigger input at the telematics unit and means for providing the vehicle sales information to a local customer responsive to the received trigger input.

The foregoing and other features and advantages of the invention will become further apparent from the following detailed description of the presently preferred embodiment, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

Various embodiments of the present invention are illustrated by the accompanying figures, wherein:

FIG. 1 is a schematic diagram of a system for providing access to a telematics system in a mobile vehicle in accordance with the present invention;

FIG. 2 is a schematic diagram of a system for providing vehicle sales information about one or more vehicles to a local customer in a mobile vehicle in accordance with the present invention;

FIG. 3 illustrates a method of providing vehicle sales information in accordance with the present invention;

FIG. 4 illustrates a method of providing local-vehicle sales information in accordance with the present invention; and

FIG. 5 illustrates a method for updating vehicle sales information in accordance with the present invention.

### DETAILED DESCRIPTION OF THE PRESENTLY PREFERRED EMBODIMENTS

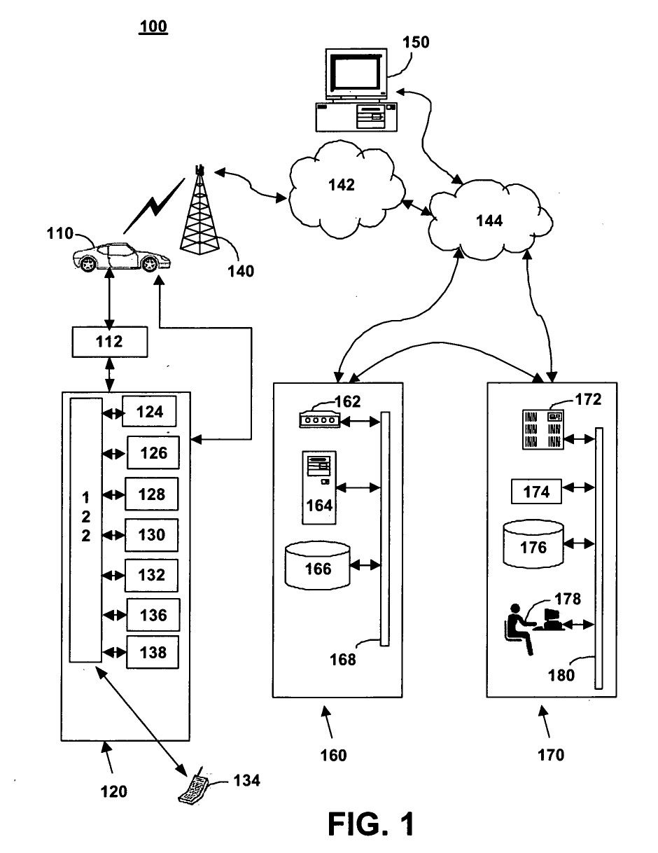

FIG. 1 is a schematic diagram of a system for providing access to a telematics system in a mobile vehicle, in accordance with the present invention at 100. Mobile vehicle communication system (MVCS) 100 includes a mobile vehicle communication unit (MVCU) 110, a vehicle communication network 112, a telematics unit 120, one or more wireless carrier systems 140, one or more communication networks 142, one or more land networks 144, one or more client, personal or user computers 150, one or more web-hosting portals 160, and/or one or more call centers 170. In one embodiment, MVCU 110 is implemented as a mobile vehicle equipped with suitable hardware and software for transmitting and receiving voice and data communications. MVCS 100 may include additional components not relevant to the present discussion. Mobile vehicle communication systems and telematics units are known in the art.

MVCU 110 may also be referred to as a mobile vehicle throughout the discussion below. In operation, MVCU 110 may be implemented as a motor vehicle, a marine vehicle, or as an aircraft. MVCU 110 may include additional components not relevant to the present discussion.

MVCU 110, via a vehicle communication network 112, sends signals to various units of equipment and systems (detailed below) within MVCU 110 to perform various functions such as unlocking a door, opening the trunk, setting personal comfort settings, and calling from telematics unit 120. In facilitating interactions among the various communication and electronic modules, vehicle communication network 112 utilizes network interfaces such as controller-area network (CAN), International Organization for Standardization (ISO) Standard 9141, ISO Standard 11898 for high-speed applications, ISO Standard 11519 for lower speed applications, and Society of Automotive Engineers (SAE) Standard J1850 for high-speed and lower speed applications, Media Oriented Systems Transport (“MOST”), Local Interconnection Network (“LIN”), and 10 Base T Ethernet and 100 Base T Ethernet.

MVCU 110, via telematics unit 120, sends and receives radio transmissions from wireless carrier system 140. Wireless carrier system 140 is implemented as any suitable system for transmitting a signal from MVCU 110 to communication network 142.

Telematics unit 120 includes a processor 122 connected to a wireless modem 124, a global positioning system (GPS) unit 126, an in-vehicle memory 128, a microphone 130, one or more speakers 132, a display 136, a replay button 138, and a portable communication device 134, such as, mobile phone or a personal digital assistant. In other embodiments, telematics unit 120 may be implemented without one or more of the above listed components. Telematics unit 120 may include additional components not relevant to the present discussion.

In one embodiment, processor 122 is a digital signal processor (DSP). Processor 122 is implemented as a microcontroller, microprocessor, controller, host processor, or vehicle communications processor. In an example, processor 122 is implemented as an application specific integrated circuit (ASIC). In another embodiment, processor 122 is implemented as a processor working in conjunction with a central processing unit (CPU) performing the function of a general purpose processor. GPS unit 126 provides longitude and latitude coordinates, as well as Coordinated Universal Time (“UST”) of the vehicle responsive to a GPS broadcast signal received from one or more GPS satellite broadcast systems (not shown). Portable communication device 134 can be a personal digital assistant with a short-range wireless communication capability or a cellular-type phone, such as, for example an analog, digital, dual-mode, dual-band, multi-mode or multi-band cellular phone.

Processor 122 executes various computer programs that control programming and operational modes of electronic and mechanical systems within MVCU 110. Processor 122 controls communications (e.g. call signals) between telematics unit 120, wireless carrier system 140, and call center 170. Processor 122 generates and accepts digital signals transmitted between telematics unit 120 and a vehicle communication network 112 that is connected to various electronic modules in the vehicle. In one embodiment, these digital signals activate the programming mode and operation modes, as well as provide for data transfers.

In one embodiment, a voice-recognition application is installed in processor 122 that can translate human voice input through microphone 130 to digital signals. In this embodiment, signals from processor 122 are translated into voice messages and sent out through speaker 132.

Communication network 142 includes services from one or more mobile telephone switching offices and wireless networks. Communication network 142 connects wireless carrier system 140 to land network 144. Communication network 142 is implemented as any suitable system or collection of systems for connecting wireless carrier system 140 to MVCU 110 and land network 144.

Land network 144 connects communication network 142 to client computer 150, web-hosting portal 160, and call center 170. In one embodiment, land network 144 is a public-switched telephone network (PSTN). In another embodiment, land network 144 is implemented as an Internet protocol (IP) network. In other embodiments, land network 144 is implemented as a wired network, an optical network, a fiber network, other wireless networks, or any combination thereof. Land network 144 is connected to one or more landline telephones. Communication network 142 and land network 144 connect wireless carrier system 140 to web-hosting portal 160 and call center 170.

Client, personal or user computer 150 includes a computer usable medium to execute Internet browser and Internet-access computer programs for sending and receiving data over land network 144 and optionally, wired or wireless communication networks 142 to web-hosting portal 160. Personal or client computer 150 sends user preferences to web-hosting portal through a web-page interface using communication standards such as hypertext transport protocol (HTTP), and transport-control protocol and Internet protocol (TCP/IP). In one embodiment, the data includes directives to change certain programming and operational modes of electronic and mechanical systems within MVCU 110. In operation, a client utilizes computer 150 to initiate setting or re-setting of user-preferences for MVCU 110. User-preference data from client-side software is transmitted to server-side software of web-hosting portal 160. User-preference data is stored at web-hosting portal 160.

Web-hosting portal 160 includes one or more data modems 162, one or more web servers 164, one or more databases 166, and a network system 168. Web-hosting portal 160 is connected directly by wire to call center 170, or connected by phone lines to land network 144, which is connected to call center 170. In an example, web-hosting portal 160 is connected to call center 170 utilizing an IP network. In this example, both components, web-hosting portal 160 and call center 170, are connected to land network 144 utilizing the IP network. In another example, web-hosting portal 160 is connected to land network 144 by one or more data modems 162. Land network 144 sends digital data to and from modem 162, data that is then transferred to web server 164. Modem 162 may reside inside web server 164. Land network 144 transmits data communications between web-hosting portal 160 and call center 170.

Web server 164 receives user-preference data from user computer 150 via land network 144. In alternative embodiments, computer 150 includes a wireless modem to send data to web-hosting portal 160 through a wireless communication network 142 and a land network 144. Data is received by land network 144 and sent to one or more web servers 164. In one embodiment, web server 164 is implemented as any suitable hardware and software capable of providing web services to help change and transmit personal preference settings from a client at computer 150 to telematics unit 120 in MVCU 110. Web server 164 sends to or receives from one or more databases 166 data transmissions via network system 168. Web server 164 includes computer applications and files for managing and storing personalization settings supplied by the client, such as door lock/unlock behavior, radio station preset selections, climate controls, custom button configurations and theft alarm settings. For each client, the web server potentially stores hundreds of preferences for wireless vehicle communication, networking, maintenance and diagnostic services for a mobile vehicle.

In one embodiment, one or more web servers 164 are networked via network system 168 to distribute user-preference data among its network components such as database 166. In an example, database 166 is a part of or a separate computer from web server 164. Web server 164 sends data transmissions with user preferences to call center 170 through land network 144.

Call center 170 is a location where many calls are received and serviced at the same time, or where many calls are sent at the same time. In one embodiment, the call center is a telematics call center, facilitating communications to and from telematics unit 120 in MVCU 110. In an example, the call center is a voice call center, providing verbal communications between an advisor in the call center and a subscriber in a mobile vehicle. In another example, the call center contains each of these functions. In other embodiments, call center 170 and web-hosting portal 160 are located in the same or different facilities.

Call center 170 contains one or more voice and data switches 172, one or more communication services managers 174, one or more communication services databases 176, one or more communication services advisors 178, and one or more network systems 180.

Switch 172 of call center 170 connects to land network 144. Switch 172 transmits voice or data transmissions from call center 170, and receives voice or data transmissions from telematics unit 120 in MVCU 110 through wireless carrier system 140, communication network 142, and/or land network 144. Switch 172 receives data transmissions from and sends data transmissions to one or more web-hosting portals 160. Switch 172 receives data transmissions from or sends data transmissions to one or more communication services managers 174 via one or more network systems 180.

Communication services manager 174 is any suitable hardware and software capable of providing requested communication services to telematics unit 120 in MVCU 110. Communication services manager 174 sends to or receives data transmissions from one or more communication services databases 176 via network system 180. Communication services manager 174 sends to or receives data transmissions from one or more communication services advisors 178 via network system 180. Communication services database 176 sends to or receives data transmissions from communication services advisor 178 via network system 180. Communication services advisor 178 receives from or sends voice or data transmissions to switch 172.

Communication services manager 174 provides one or more of a variety of services, including enrollment services, navigation assistance, directory assistance, roadside assistance, business or residential assistance, information services assistance, emergency assistance, and communications assistance. Communication services manager 174 receives service-preference requests for a variety of services from the client via computer 150, web-hosting portal 160, and/or land network 144. Communication services manager 174 transmits user-preference and other data to telematics unit 120 in MVCU 110 through wireless carrier system 140, communication network 142, land network 144, voice and data switch 172, and network system 180. Communication services manager 174 stores or retrieves data and information from communication services database 176. Communication services manager 174 may provide requested information to communication services advisor 178.

In one embodiment, communication services advisor 178 is implemented as a real advisor. In an example, a real advisor is a human being in verbal communication with a user or subscriber (e.g. a client) in MVCU 110 via telematics unit 120. In another embodiment, communication services advisor 178 is implemented as a virtual advisor. In an example, a virtual advisor is implemented as a synthesized voice interface responding to requests from telematics unit 120 in MVCU 110.

Communication services advisor 178 provides services to telematics unit 120 in MVCU 110. Services provided by communication services advisor 178 include enrollment services, navigation assistance, real-time traffic advisories, directory assistance, roadside assistance, business or residential assistance, information services assistance, emergency assistance, and communications assistance. Communication services advisor 178 communicate with telematics unit 120 in MVCU 110 through wireless carrier system 140, communication network 142, and/or land network 144 using voice transmissions, or through communication services manager 174 and switch 172 using data transmissions. Switch 172 selects between voice transmissions and data transmissions.

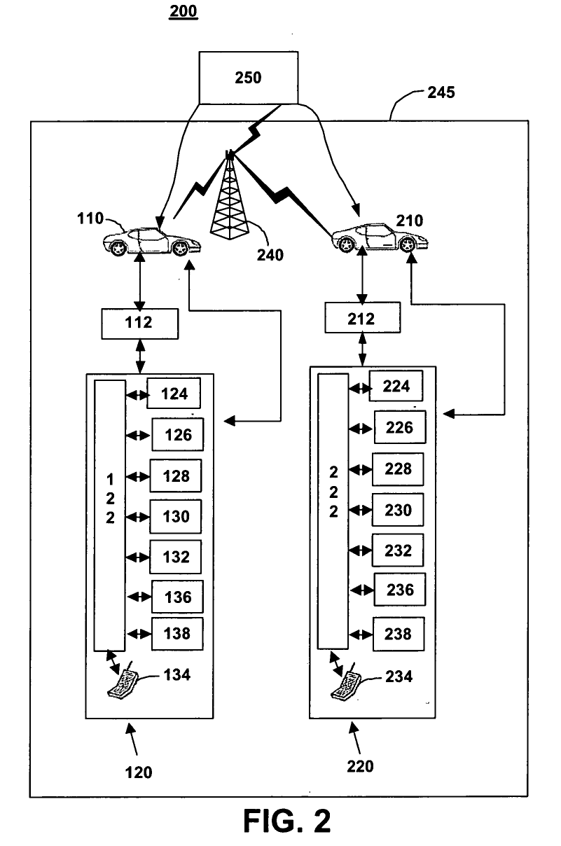

FIG. 2 is a schematic diagram of a system for providing vehicle sales information about one or more local-vehicles 210 to a local customer in a mobile vehicle 110 in accordance with the present invention at 200.

Mobile vehicle communication system (MVCS) 200 includes MVCU 110, at least one local-mobile vehicle communication unit (local-MVCU) 210, a control node 250, and one or more local wireless system nodes 240. The local-MVCU 210 includes a telematics unit 220. In operation, local-MVCU 210 may be implemented as a motor vehicle, a marine vehicle, or as an aircraft. Local-MVCU 210 may also be referred to as a local-vehicle 210 throughout the discussion below. Local-MVCU 210 is any MVCU which is geographically located so as to enable wireless communications with MVCU 110.

Local-MVCU 210, via a vehicle communication network 212, sends signals to various units of equipment and systems within local-MVCU 210 to perform various functions such as unlocking a door, opening the trunk, setting personal comfort settings, and calling from telematics unit 220.

Telematics unit 220 includes a processor 222 connected to a wireless modem 224, a global positioning system (GPS) unit 226, an in-vehicle memory 228, a microphone 230, one or more speakers 232, an embedded or in-vehicle portable communication device 234, a display 236 and a replay button 238. In-vehicle portable communication device 234 can be a personal digital assistant with a short-range wireless communication capability or a cellular-type phone, such as, for example an analog, digital, dual-mode, dual-band, multi-mode or multi-band cellular phone.

In other embodiments, telematics unit 220 may be implemented without one or more of the above listed components. Telematics unit 220 may include additional components not relevant to the present discussion.

In one embodiment, processor 222 is a digital signal processor (DSP), which functions in the same manner as processor 122 described above with reference to FIG. 1. GPS unit 226, embedded or in-vehicle portable communication device 234, and vehicle communication network 212 function in the same manner as GPS unit 126, a portable communication device 134, and vehicle communication network 112, respectively, described above with reference to FIG. 1.

The telematics unit 120 in the MVCU 110 establishes a local wireless link to a local wireless network. The local wireless network includes one or more local wireless network nodes 240, MVCU 110 and one or more local-vehicles 210 in a dealership lot 245.

In one embodiment, the local wireless network is a short-range wireless network and the local-vehicle sales information and the local-vehicle locations are embedded in a short-range wireless signal. In this embodiment, short-range wireless receivers and transmitters are in located in the telematics units 110 and 210 and in one or more local wireless network nodes 240. The short-range wireless receivers and transmitters can be Wi-Fi and/or Bluetooth devices as is known in the art. In this embodiment, telematics units 110 and 210 include short-range wireless receiver chips that are compatible with the Wi-Fi and/or Bluetooth technologies. As used herein, the term “wi-fi” includes any radio transmission configured to broadcast within a limited range, such as less than one mile, and includes transmissions made under an industry standard, such as FCC part 15. “Wi-fi” includes, but is not limited to, 802.11 transmissions.

The control node 250 provides vehicle sales information to the telematics unit 120 in MVCU 110 and telematics unit 220 in local-MVCU 210. The control node 250 can be a distributed node and includes one or more of the vehicle factories (not shown) where the MVCU 110 and local-MVCU 210 were manufactured, one or more call centers 170, the vehicle dealership where the MVCU 110 and local-MVCU 210 are located, and one or more service provider facilities (not shown). The vehicle dealership includes dealership lot 245, and in one embodiment, includes other facilities relating to vehicle sales, such as a regional sales office or other similar network of dealerships for the same make or different makes of vehicles.

The vehicle sales information and local-vehicle sales information are transmitted as data signals to the telematics unit 120 and telematics unit 220, respectively, from the control node 250 either directly via one or more wireless carrier systems 140, one or more communication networks 142, one or more land networks 144, one or more client, personal or user computers 150, one or more web-hosting portals 160, one or more call centers 170 and/or indirectly through one or more local wireless system nodes 240. In one embodiment, wireless carrier systems 140, one or more communication networks 142, one or more land networks 144, one or more client, personal or user computers 150, one or more web-hosting portals 160, one or more call centers 170 are implemented as in FIG. 1. In one embodiment, the vehicle sales information input at the vehicle factory is downloaded directly from a computer (not shown) in the vehicle factory.

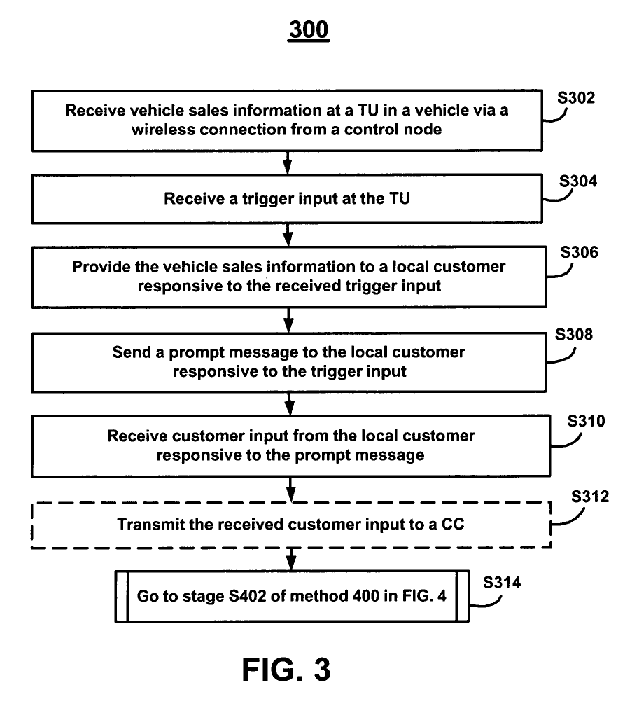

FIG. 3 illustrates a method 300 of providing vehicle sales information in accordance with the present invention. The telematics unit 120 and the processor 122 within the MVCU 110, the telematics unit 220, the processor 222 within the LOCAL-MVCU 210, the central node 150, and the call center 170 have stored in computer readable medium at least one computer program including computer readable code to perform the operations described with reference to method 300.

During stage S302, the telematics unit (TU) 120 in a MVCU 110 receives vehicle sales information via a wireless connection from a control node 250. In one embodiment, the vehicle sales information includes the make, model and color of the vehicle, price information for the vehicle, price information for the MVCU 110, components in the MVCU 110, price information for the components, available navigation systems, price information for the available navigation systems, available service options related to the components, price information for the available service options related to the components, vehicle features, price information for the vehicle features, safety features of the MVCU 110, fuel efficiency of the MVCU 110, optional towing packages, price information for the towing packages, available off-road packages, price information for the available off-road packages, available warranty packages, price information for the available warranty packages, special regional price discounts on the MVCU 110, marketing videos for one or more available service options for the MVCU 110, price information for the one or more available service options for the MVCU 110, marketing videos for one or more available service options for the components, price information for the one or more available service options for the components, instructional videos for the available components, optional components not installed in the MVCU 110, optional vehicle features not on the MVCU 110, optional navigation systems not installed in the MVCU 110, warranty information for the vehicle, warranty information for the vehicle components, and combinations thereof.

The components in the vehicle include, for example, a telematics unit 120, a radio, a satellite radio, a vehicle navigation system, an entertainment unit, a display 136, a heads-up display, a telephone, a portable communication device 134, a personal digital assistant, a speaker system, a voice recognition system, a television, a compact disc player, a digital video disc player, and combinations thereof.

The vehicle sales information can be provided from one central location such as the vehicle dealership. In this case, the central location receives the vehicle sales information from various sources, and transmits it to the telematics units 110 in the vehicle on the dealership lot 245.

In one embodiment, the vehicle sales information is provided from the entity that generated the specific information. For example, the price information, warranty information, and marketing videos for the MVCU 110 are, in one embodiment, received from the vehicle dealership or a regional sales office of the vehicle dealership since the vehicle dealership or a regional sales office set the prices, establish warranty packages and generate marketing videos for the vehicles. In one embodiment, the marketing videos for one or more available service options for the components are received from one or more service provider facilities.

In a like manner, the local-vehicle sales information is received at a local-vehicle 210 via a wireless connection from a control node 250.

During stage S304, the telematics unit (TU) 120 receives a trigger input. As used herein, a trigger input is an input configured to result in providing vehicle sales information. The trigger input includes, in various embodiments, opening a vehicle door, pushing a button on the telematics unit 120, sitting in a seat of a MVCU 110, turning on the MVCU 110, announcing a vehicle sales information command to the telematics unit 120 and combinations thereof.

The vehicle dealership may have information available to the customers entering the dealership lot 245 about how to send the trigger input to the telematics unit. For example, signs may be posted in the vehicle showroom instructing the prospective customers to sit in the drivers seat and announce, “Tell me about this vehicle,” to get vehicle sales information from the telematics unit 120 in the MVCU 110. In this embodiment, the microphone 130 receives the utterance from the customer announcement and converts the utterance to a digital or analog signal, a speech recognition system in the MVCU 110 recognizes the digital or analog signal and, based on the recognition, transmits instructions to the processor 122 which triggers the telematics unit 120 to provide the vehicle sales information to the customer or customers sitting in the vehicle 110.

In other embodiments, a customer is provided with a handheld communication device configured for wireless communication with the telematics units of each MVCU 110, 210. For example, a laptop, pocket PC, cellular telephone, or other portable device can be configured to provide vehicle sales information via audible or visual display, and to communicate with the telematics units, 120, 220, to request further information. The handheld communication device, in one embodiment, is configured to directly issue a command as a trigger input.

During stage S306, the telematics unit 120 provides the vehicle sales information to the local customer responsive to the received trigger input. The local customer is defined herein as the customer who initiates the trigger input, a person with the trigger-initiating customer, and/or the customer who is in a vehicle with a vehicle salesperson who initiates the trigger input. The local customer can include more than one customer sitting the MVCU 110, such as, members of a family.

In one embodiment, the vehicle sales information is provided visually on a display 136 in the MVCU 110. In another embodiment, the vehicle sales information is audibly provided over speakers 132 in the MVCU 110. In yet another embodiment, at least a portion of the vehicle sales information is provided visually on a display 136 in the MVCU 110 and at least a portion of the vehicle sales information is audibly provided over speakers 132 in the MVCU 110. For example, the marketing videos can show a movie and play music as background to an audio description of what is showing in the movie.

In another embodiment, the vehicle sales information is provided visually on a display in the portable communication device 134. In yet another embodiment, at least a portion of the vehicle sales information is provided as audio-visual information on the portable communication device 134. For example, the marketing videos can be transmitted via short-range wireless technology from the telematics unit 120 to be displayed on a personal digital assistant in the MVCU 110.

The telematics unit 120 provides the local customer with a replay option that can be selected by pushing a replay button 138 in the telematics unit 120. In one embodiment, a replay button 138 is pushed by the local customer to have a last segment of vehicle sales information repeated. In another embodiment, the replay button 138 is pushed more than one time by the local customer to proceed backward through the vehicle sales information until a portion of the local customer reaches the portion of vehicle sales information they want to hear/see again. In yet another embodiment, the customer announces “replay” or similar commands to have a last segment of vehicle sales information repeated. In this case, the telematics unit 120 operates on the replay command as described above with reference to announcing a vehicle sales information command during stage S304.

Likewise, the local customer can stop receiving the vehicle sales information by pushing a stop button (not shown). The stop button can be on the telematics unit 120, or on a button in communication with the telematics unit 120, or it can be a menu option displayed with the vehicle sales information on a small portion of the display 136. In one embodiment, the local customer can stop receiving the vehicle sales information by announcing “stop.” In this case, the telematics unit 120 operates on the stop command as described above with reference to announcing a vehicle sales information command during stage S304.

During stage S308, the telematics unit 120 sends a prompt message to the local customer responsive to the received trigger input. The prompt message requests the local customer to provide customer input, such as, the customer preferences in a vehicle, a customer zip code, customer home address, customer phone number and a customer email address. In one embodiment, the customer zip code is required to determine the availability of various vehicle service options. The prompt message can be sent to the local customer within the first few minutes of beginning to provide vehicle sales information. A prompt message can be sent to the local customer after the vehicle sales information provides input on various service options.

In an exemplary embodiment, the telematics unit presents a market video for optional navigation systems followed by an audio prompt message, “If you would like a navigation system in your vehicle, press YES on the menu in the display,” while a YES/NO menu is displayed on the display 136. In another exemplary embodiment, after the telematics unit 120 lists available off-road packages on the display 136, a prompt message is displayed with a YES/NO menu and the instruction, “Press YES if you would like an off-road package.”

In one embodiment, the prompt message is provided by verbal communication with one or more communication services advisors 178 at the call center 170. In this case, the telematics unit 120 transmits a pre-prompt message to the call center 170 to establish a connection between the call center 170 and the telematics unit 120.

In one embodiment, the prompt message is repeated one time if the local customer does not respond within a preset time. The preset time is stored in an in-vehicle memory 128 in, or in communication with, the telematics unit 120. In another embodiment, the remaining vehicle sales information is provided if the local customer does not respond within a preset time. In yet another embodiment, the presentation of vehicle sales information is terminated if the local customer does not respond within a preset time.

In an exemplary embodiment, a clock (not shown) in the processor 122 is set to zero when the prompt message is read, and starts counting time in predetermined increments upon completion of the prompt message. When the elapsed time on the clock matches the preset time stored in an in-vehicle memory 128, the prompt message is repeated and the clock is reset to zero. Then, when the elapsed time on the reset clock reaches the preset time, telematics unit continues to provide remaining vehicle sales information.

During stage S310, the telematics unit 120 receives customer input from the local customer responsive to the prompt message sent during stage S308. The customer input from the local customer is provided by at least one of verbal statements of the local customer, one or more touches on a menu on a display screen by the local customer, and one or more button pushes on the telematics unit 120 by the local customer.

In one embodiment, during stage S312, the telematics unit 120 transmits the customer input received from the local customer during stage S310 to the call center (CC) 170. The call center 170 transmits information to the local customer based on the customer input received during stage S310. In an exemplary embodiment, brochures are sent to the home address provided by the local customer. The brochures can describe features of the MVCU 110 or other vehicles that have the desired vehicle features. In another embodiment, the addresses of web sites with access to information on desired vehicle features are emailed to the email address received from the local customer.

The customer input is transmitted to the call center 170 via one or more wireless carrier systems 140, one or more communication networks 142, one or more land networks 144, one or more client, personal or user computers 150, one or more web-hosting portals 160.

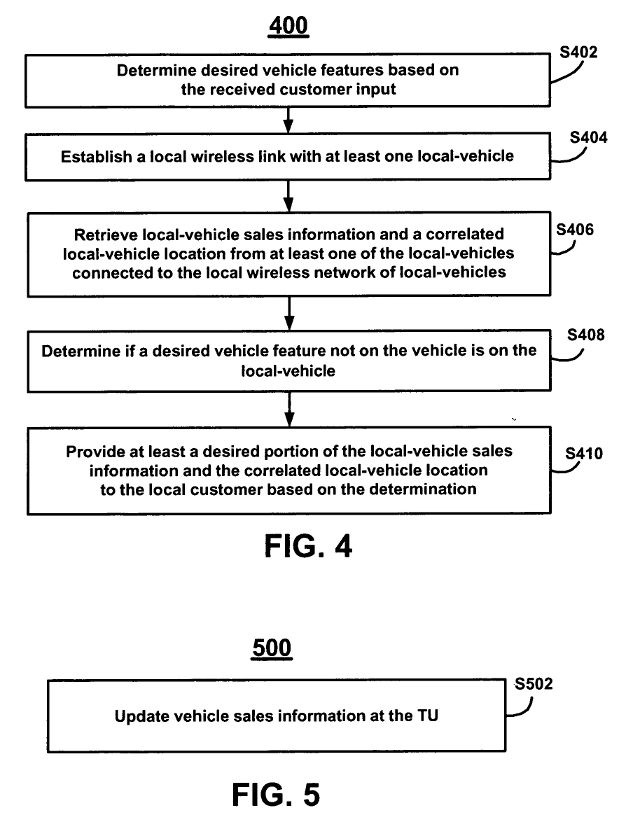

In one embodiment, method 300 is directed, during stage S314, to stage S402 of method 400 in FIG. 4.

FIG. 4 illustrates a method 400 of providing local-vehicle sales information in accordance with the present invention. In this embodiment, the telematics unit 120 receives local-vehicle sales information from one or more local-vehicles 210 via the local wireless network and provides at least a portion of the local-vehicle sales information to the local customer. Local-vehicle sales information is the vehicle sales information for the local-vehicles 210 on the dealership lot 245.

In one embodiment, the telematics unit 120 provides local-vehicle sales information to the local customer if the desired feature is in the local-vehicle 120 and not in the MVCU 110. In another embodiment, the telematics unit 120 provides local-vehicle sales information to the local customer if most or all of the desired features are in the local-vehicle 120.

The telematics unit 120, the in-vehicle memory 128 and the processor 122 within the MVCU 110, the telematics unit 220, the in-vehicle memory 228 and the processor 222 within the local-MVCU 210, and/or the one or more local wireless system nodes 240 have stored in computer readable medium at least one computer program including computer readable code to perform the operations described with reference to method 400.

During stage S402, telematics unit 120 determines desired features based on the customer input received during stage S310. The desired features are stored in the in-vehicle memory 128 in, or in communication with, the telematics unit 120. In one embodiment, the desired features are temporarily stored in the in-vehicle memory 128 until the local customer terminates the provision of vehicle sales information.

During stage S404, the telematics unit 120 establishes a local wireless link with at least one local-vehicle 210 connected to a local wireless network of local-vehicles 210. As described above with reference to FIG. 2, the local wireless network can be a short-range wireless network and includes one or more local wireless network nodes 240, MVCU 110 and one or more local-vehicles 210 in a dealership lot 245. The local wireless network may also be an ad-hoc network created in response to an inquiry from telematics unit 120, and may be formed as a peer-to-peer network.

During stage S406, the telematics unit 120 retrieves local-vehicle sales information and a correlated local-vehicle location from at least one of the local-vehicles 210 connected to the local wireless network of local-vehicles 210. The telematics unit 120 transmits a request for local-vehicle sales information and a local-vehicle location via the one or more local wireless system nodes 240 to all the local-vehicles 210 in the dealership lot. The telematics unit 120 also transmits the longitude and latitude coordinates of the MVCU 110 to the telematics units 220 of all the local-vehicles 210 via the one or more local wireless system nodes 240. Vehicle locations are determined using any appropriate means, and include GPS transmitters, as well as signal triangulation techniques. Distances may be calculated by any appropriate means, including comparison of multiple GPS locations, as well as signal attenuation techniques.

The local-vehicle sales information includes the same type of information about local-vehicle 210 as the vehicle sales information listed above with reference to stage S302 of method 300 in FIG. 3. The local-vehicle sales information for the local-vehicle 210 is stored in the in-vehicle memory 228 in the local-vehicle 210. Responsive to the request for local-vehicle sales information from telematics unit 110, the processor 222 in telematics unit 220 retrieves the stored local-vehicle sales information.

The location of the local-vehicles 210 with respect to MVCU 110 is defined herein as the local-vehicle location. The telematics unit 220 receives the longitude and latitude coordinates of the MVCU 110 sent by telematics unit 120. The telematics unit 220 retrieves the longitude and latitude coordinates of the local-MVCU 210 in response to the request for local-vehicle location. The processor 222 calculates the vector difference between the longitude and latitude coordinates of the MVCU 110 and the longitude and latitude coordinates of the local-MVCU 210. The processor 222 then calculates a direction and a distance from the MVCU 110 to the local-MVCU 210, such as, “East-100 meters”, which indicates the local-MVCU 210 is east of the MVCU 110 by 100 meters. The direction and distance from the MVCU 110 and the local-MVCU 210 is the local-vehicle location of the local-MVCU 210.

In one embodiment, the telematics unit 210 sends the longitude and latitude coordinates of the local-MVCU 210 to the telematics unit 110. Then, the processor 122 in the telematics unit 110 calculates the local-vehicle location. In some embodiments, the telematics unit 110 calculates the local-vehicle location only if the local-MVCU 210 includes a desired feature.

The telematics unit 220 transmits the retrieved local-vehicle sales information and the local-vehicle location of the local-MVCU 210 as correlated data to the telematics unit 120 via one or more local wireless system nodes 240.

During stage S408, the telematics unit 120 determines if a desired vehicle feature that is not on the MVCU 110 is on the local-vehicle 210. The processor 122 compares the vehicle sales information stored in the in-vehicle memory 128 with the desired vehicle features of the local customer, which were stored in the in-vehicle memory 128 during stage S402. Any desired vehicle features that are not in the MVCU 110 are stored in the in-vehicle memory 128 as missing-desired vehicle features.

The processor 122 compares the local-vehicle sales information for each local-vehicle 210 with the missing-desired vehicle features stored in the in-vehicle memory 128.

In one embodiment, the telematics unit 120 determines if at least a portion of the retrieved local-vehicle sales information matches the desired vehicle features, irrespective of any missing-desired vehicle features. In this case, the processor 122 compares the local-vehicle sales information for each local-vehicle 210 with the desired vehicle features stored in the in-vehicle memory 128 and determines if there is a match.

During stage S410, the telematics unit 120 provides at least a desired portion of the local-vehicle sales information and the correlated local-vehicle location to the local customer based on the determination. If a local-vehicle 220 has one or more of the missing-desired vehicle features, the local customer receives a local-vehicle notification from the telematics unit. The local-vehicle notification includes at least the missing-desired vehicle features and the local-vehicle location. In one embodiment, the local-vehicle notification includes the missing desired vehicle features, the local-vehicle location, and the make, model and color of the local-vehicle.

In another embodiment, the telematics unit 120 determines if at least a portion of the retrieved local-vehicle sales information matches the all the desired vehicle features and the local-vehicle notification includes the all desired vehicle features and the correlated local-vehicle location.

In one embodiment, the local-vehicle notification is visually displayed on display 136. In another embodiment, the local-vehicle notification is visually displayed on a portable communication device 134, such as, a mobile phone or a personal digital assistant. In another embodiment, the local-vehicle notification is announced over speakers 132. In this embodiment, missing-desired vehicle features and the local-vehicle location data is translated into voice messages by a speech generation algorithm in the speech recognition system and sent out through speaker 132.

Exemplary local-vehicle notifications can be displayed as or announced as:

“A blue vehicle located 50 yards to the west of this vehicle has a satellite radio, the advanced navigation system, four-wheel drive and is priced within your desired price range”;

“A green sedan with beige interior, heated seats and an anti-lock brake system is located 30 yards south of this vehicle”; or

“A red sports convertible with black leather seats in the lot has all the features you desire. This red sports convertible is located 15 meters west of the vehicle in which you are sitting”.

The method 300 and the method 400 are terminated at any point in the flow by a termination command from the local customer. The termination command can be: a verbal announcement, such as, “Stop” a menu selection labeled “Exit” or “Stop” or a button press on a button on the telematics unit 120. If the local customer does not terminate the flow, the method 300 and the method 400 are terminated after all the vehicle sales information and local-vehicle sales information are presented to the local-customer.

FIG. 5 illustrates a method 500 of updating vehicle sales information at the telematics unit 120 in accordance with the present invention. The telematics unit 120, the in-vehicle memory 128 and the processor 122 within the MVCU 110 have stored in computer readable medium at least one computer program including computer readable code to perform the operations described with reference to method 400.

During stage S502, the telematics unit 120 updates vehicle sales information at the telematics unit (TU) 120. In one embodiment, the telematics unit 120 retrieves vehicle component information from components in the MVCU 110 via a vehicle bus in the MVCU 110. The vehicle bus can be the vehicle communication network 112. In another embodiment, the telematics unit 120 retrieves vehicle component information using a Radio Frequency Identifier (“RFID”) interface. The telematics unit 120 checks the retrieved vehicle component information and determines if it matches the vehicle component information stored in the in-vehicle memory 128 as part of the vehicle sales information. If a vehicle component, such as, a radio is changed on the MVCU 110 while on the dealership lot 245, the telematics unit 120 determines the component information is different. The telematics unit 120 deletes the stored vehicle component information from the in-vehicle memory 128 and stores the updated vehicle component information in the in-vehicle memory 128. In this manner the vehicle sales information related to the components on the MVCU 110 remains current.

In one embodiment, the telematics unit 120 periodically retrieves vehicle component information from components in the MVCU 110. In another embodiment, the telematics unit 120 retrieves vehicle component information from components in the MVCU 110 when triggered by a dealership program code which is transmitted to the telematics unit 120 from the control node 250 via one or more local wireless system nodes 240.

If any price related to the MVCU 110 or the service options for the MVCU 110 are changed while the MVCU 110 is on the dealership lot 245, the control node 250 broadcasts the price change to the telematics unit 120 via one or more local wireless system nodes 240 to all the vehicles on the dealership lot 245. Then the telematics unit 120 in each vehicle deletes the old price information from the in-vehicle memory 128 and stores the updated price information in the in-vehicle memory 128. In this manner the vehicle sales information related to price information remains current and is simultaneously updated on all the vehicles in the dealership lot 245.

While the embodiments, of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

What is claimed is:

1. A method to provide vehicle information, comprising:
receiving vehicle sales information at a telematics unit in a vehicle via a wireless connection from a control node;
receiving a trigger input at the telematics unit; and
providing at least a portion of the vehicle sales information to a local customer responsive to the received trigger input.

2. The method of claim 1, wherein the trigger input is selected from the group consisting of opening a vehicle door, pushing a button on the telematics unit, sitting in a seat of a vehicle, turning on the vehicle, announcing a vehicle sales information command to the telematics unit and combinations thereof.

3. The method of claim 1, wherein the vehicle sales information is selected from the group consisting of make, model and color of the vehicle, price information for a vehicle, components in the vehicle, price information for the components, available navigation systems, price information for the available navigation systems, available service options related to the components, price information for the available service options related to the components, vehicle features, price information for the vehicle features, safety features of the vehicle, fuel efficiency of the vehicle, optional towing packages, price information for the towing packages, available off-road packages, price information for the available off-road packages, available warranty packages, price information for the available warranty packages, special regional price discounts on the vehicle, marketing videos for one or more available service options for the vehicle, price information for the one or more available service options for the vehicle, marketing videos for one or more available service options for the components, price information for the one or more available service options for the components, instructional videos for the available components, optional components not installed in the vehicle, optional vehicle features not on the vehicle, optional navigation systems not installed in the vehicle, and combinations thereof.

4. The method of claim 3, wherein the components in the vehicle are selected from the group consisting of a telematics unit, a radio, a satellite radio, a vehicle navigation system, an entertainment unit, a display, a heads-up display, a telephone, a portable communication device, a personal digital assistant, a speaker system, a voice recognition system, a television, a compact disc player, a digital video disc player, and combinations thereof.

5. The method of claim 1, wherein the vehicle sales information is provided visually on a display in the vehicle.

6. The method of claim 1, wherein the vehicle sales information is audibly provided over speakers in the vehicle.

7. The method of claim 1, wherein at least a portion of the vehicle sales information is provided visually on a display in the vehicle and at least a portion of the vehicle sales information is audibly provided over speakers in the vehicle.

8. The method of claim 1, further comprising:
updating vehicle sales information at the telematics unit.

9. The method of claim 1, further comprising:
sending a prompt message to the local customer responsive to the trigger input;
receiving customer input from the local customer responsive to the prompt message;
determining desired vehicle features based on the received customer input; and
establishing a local wireless link with at least one local-vehicle connected to a local wireless network of local-vehicles.

10. The method of claim 9, wherein the customer input from the local customer is provided by at least one of utterances of the local customer, one or more touches on a menu on a display screen by the local customer, and one or more button pushes on the telematics unit by the local customer.

11. The method of claim 9, further comprising:
retrieving local-vehicle sales information and a correlated local-vehicle location from at least one of the local-vehicles connected to the local wireless network of local-vehicles;
determining if a desired vehicle feature not on the vehicle is on the local-vehicle; and
providing at least a desired portion of the local-vehicle sales information and the correlated local-vehicle location to the local customer based on the determination.

12. The method of claim 9, further comprising:
retrieving local-vehicle sales information and a correlated local-vehicle location from at least one of the local-vehicles connected to the local wireless network of local-vehicles;
determining if at least a portion of the retrieved local-vehicle sales information matches the desired vehicle features; and
providing at least a desired portion of the local-vehicle sales information and the correlated local-vehicle location to the local customer based on the determination.

13. The method of claim 9, further comprising:
transmitting the received customer input to a call center wherein the call center transmits information to the local customer based on the received customer input.

14. The method of claim 1, further comprising;
providing the local customer with a replay option.

15. A computer readable medium storing a computer program comprising:
computer readable code for receiving vehicle sales information at a vehicle telematics unit via a wireless connection from a control node;
computer readable code for receiving a trigger input at the telematics unit; and
computer readable code for providing at least a portion of the vehicle sales information to a local customer responsive to the received trigger input.

16. The medium of claim 15, further comprising:
computer readable code for sending a prompt message to the local customer responsive to the trigger input;
computer readable code for receiving customer input from the local customer responsive to the prompt message;
computer readable code for determining desired vehicle features based on the received customer input; and
computer readable code for establishing a wireless link with at least one local-vehicle connected to a local wireless network of local-vehicles.

17. The medium of claim 16, further comprising:
computer readable code for retrieving local-vehicle sales information and a correlated local-vehicle location from at least one of the local-vehicles connected to the local wireless network of local-vehicles;
computer readable code for determining if a desired vehicle feature not on the vehicle is on the local-vehicle; and
providing at least a desired portion of the local-vehicle sales information and the correlated local-vehicle location to the local customer based on the determination.

18. The method of claim 16, further comprising:
computer readable code for transmitting the received customer input to a call center wherein the call center transmits information to the local customer based on the received customer input.

19. A system to provide vehicle information, comprising:
means for receiving vehicle sales information at a vehicle telematics unit via a wireless connection from a control node;
means for receiving a trigger input at the telematics unit; and
means for providing the vehicle sales information to a local customer responsive to the received trigger input.

20. The system of claim 1, further comprising:
means for sending a prompt message to the local customer responsive to the trigger input;
means for receiving customer input from the local customer responsive to the prompt message;
means for determining desired vehicle features based on the received customer input; and
establishing a wireless link with at least one local-vehicle connected to a local wireless network of local-vehicles.
